(19) United States
(12) Patent Application Publication
(10) Pub. No.: US 2005/0204297 A1
(43) Pub. Date: Sep. 15, 2005

(54) Combined synchronous and asynchronous logical components in a collaborative context

(75) Inventors: Mustansir Banatwala, Hudson, NH (US); Miguel A. Estrada, Hollis, NH (US); Charles R. Hill, Belmont, MA (US); Sami M. Shalabi, Arlington, MA (US); Thomas M. Spine, Londonderry, NH (US)

Correspondence Address: Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/744,302

(22) Filed: Dec. 22, 2003

(51) Int. Cl. G06F 3/00

(52) U.S. Cl. 715/753; 715/741; 715/751; 715/752

(57) ABSTRACT

The present invention is a method, system and apparatus for combining synchronous and asynchronous collaborative components in a single collaborative content. A named collaborative context can include a selection of collaborators in a membership and at least one role applied to the collaborators. The named collaborative context can further include a selection of resources for use by the collaborators. Most importantly, the named collaborative context can include an ad hoc mix of synchronous and asynchronous tools. Preferably, the named collaborative can also include a template defining the selection of collaborators, the role or roles applied to the collaborators, the selection of resources, and the ad hoc mix.

### BACKGROUND OF THE INVENTION

1. Statement of the Technical Field

The present invention relates to the field of collaborative computing and more particularly to the aggregation of collaborative components in a collaborative context.

2. Description of the Related Art

The rapid development of the Internet has led to advanced modes of communication and collaboration. Using the Internet as a backbone, individuals worldwide can converge in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include both static synchronous forms of collaboration such as instant messaging and application sharing, and asynchronous forms of collaboration such as discussion forums and document libraries.

Conventional collaborative computing includes statically produced combinations of synchronous and asynchronous collaborative technologies in order to provide a means for members of a collaborative community to pool the strengths and experiences of the collaborators to achieve a common goal. A collaborative computing environment generally can be defined by (1) a particular context, specifically the objective of the environment, (2) membership, specifically the participants in the environment, (3) a set of roles for the members, and (4) resources and tools which can be accessed by the membership in furtherance of the objective of the environment. Roles are names given to the people in the environment which dictate access to the resources and tools within the environment as well as define the behavior of the community members.

Collaborative computing environments typically can be statically customized at the time of development by the developer of each environment in order to meet the needs both of developers and users. For instance, several customized collaborative computing environments have been created such as team workspaces, e-meetings, virtual classrooms and virtual communities. Notably, each of these types of environments has been implemented using shared resources as a building block to create the environment. Nevertheless, customized collaborative computing environments can be rigid and immutable due to their development-time customization. In this regard, the unique combination of collaborative tools combined within the collaborative environment can be fixed and unchangeable by the developer prior to distributing the environment to the end users.

Because of the fixed nature of the conventional collaborative environment, information technology (IT) groups within the enterprise have been burdened with the responsibility of building customized collaborative environments for their constituent enterprise customers. Additionally, the IT groups have been charged with supporting and maintaining the customized collaborative environments for their constituent enterprise customers. Nevertheless, in an on-demand world, customers simply are not willing to wait for the IT department to deploy customized collaborative environments when required by the enterprise. Thus, self-service applications and end user self-provisioning have become important to the enterprise.

In a self-service, self-provisioning environment, the end user him or herself is empowered to create new instances of statically configured collaborative environments on demand. In this regard, the on-demand, self-provisioning qualities are at the core of any cutting edge collaborative computing environment. Self-service collaborative systems allow collaborators to initiate and create instances of a statically templated collaborative environment when and where the collaborators demand a collaborative environment. Self-service collaborative systems further allow collaborators to manage the collaborative resources in the environment on demand without requiring specific expertise outside of the group of collaborative participants in the collaborative community.

Still, to replicate a static arrangement of collaborative tools disposed within a collaborative context—even in a self-provisioning, on-demand manner—cannot provide the flexibility required by end users in a collaboration. Rather, end users must be able to create dynamically customizable combinations of both synchronous and asynchronous collaborative tools in a collaborative environment in a self-provisioning, on-demand manner. Nevertheless, in a conventional self-provisioning, on-demand collaborative environment, self-provisioning and dynamic customization remain mutually exclusive concepts.

### SUMMARY OF THE INVENTION

The present invention addresses the deficiencies of the art in respect to the aggregation of logical components in a collaborative context in a collaborative environment and provides a novel and non-obvious method, system and apparatus for combining synchronous and asynchronous collaborative components in a single dynamically arrangeable collaborative context which can be created in an ad-hoc, self-provisioning, on-demand manner. Thus, the present invention can include a named collaborative context having an ad hoc combination of synchronous and asynchronous tools defined therein.

In accordance with the present invention, a named collaborative context can include a selection of collaborators in a membership and at least one role applied to the collaborators. The named collaborative context can further include a selection of resources for use by the collaborators. Most importantly, the named collaborative context can include an ad hoc mix of synchronous and asynchronous tools. Preferably, the named collaborative can also include a template defining the selection of collaborators, the role or roles applied to the collaborators, the selection of resources, and the ad hoc mix.

In a preferred aspect of the invention, a named collaborative context instance can include a selection of collaborators in a membership. The named collaborative context instance further can include at least one role applied to the collaborators. The named collaborative context instance yet further can include a selection of resources for use by the collaborators. Finally, the named collaborative context instance can include an ad hoc mix of synchronous and asynchronous tools. Preferably, the named collaborative context instance can be disposed in a portal user interface encapsulating the ad hoc mix of synchronous and asynchronous tools.

Notably, a named collaborative space creation method can include rendering each of a list of collaborators in a membership, a list of roles which can be applied to the collaborators, a selection of resources which can be used by the collaborators, and a listing of a set of synchronous tools and asynchronous tools which can be accessed by the collaborators. A set of collaborators can be selected from the list of collaborators and selected ones of the roles can be applied to individual ones of the collaborators. At least one resource can be further selected for use by the selected set of collaborators. Moreover, an ad hoc mix of the synchronous and asynchronous tools for use by the selected set of collaborators can be yet further selected. Finally, the named collaborative space can be defined with the selected set of collaborators, the further selected at least one resource, and the yet further selected ad hoc mix of tools.

In a preferred embodiment of the present invention, the defining step further can include the step of persisting the definition in a template configured for use in creating instances of the named collaborative space. Also, the named collaborative space can be registered in a catalog for viewing in a collaborative environment. Based upon the registration, individual collaborators can create instances of the named collaborative space. Yet the creation of the instances by administrative ones of the collaborators can be limited based upon at least one role assigned to the administrative collaborators.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a collaborative context configured to combine therein both synchronous and asynchronous components in a self-provisioning, on-demand manner;

FIG. 2 is a schematic illustration of a named collaborative context instance created from an ad hoc combination of synchronous and asynchronous components; and,

FIG. 3 is a flow chart illustrating a process for creating a template for named collaborative context instances including dynamically selectable combinations of synchronous and asynchronous components.

### DETAILED DESCRIPTION OF THE PREFERRED EMBODIMENTS

The present invention is system, method and apparatus for combining synchronous and asynchronous collaborative components in a single self-provisioning, on-demand collaborative content. In particular, a dynamically customizable collaborative context can be provided. The dynamically customizable context, referred to herein as a “named collaborative space”, can include an arrangement of collaborators in a membership defined to pursue a common objective through the use of a collaborative computing environment. The named collaborative space further can include one or more logical components, referred to as collaborative tools, and one or more resources for use by the collaborators through the tools in the collaborative environment. Importantly, roles can be assigned to the collaborators which can limit or enhance access by the collaborators to different tools and resources in the named collaborative space.

The arrangement of collaborators, roles, tools and resources can be specified through a templating mechanism in which the arrangement can be defined in a template, named according to the common objective and processed at the time of creating the named collaborative space to produce the customized collaborative environment. Importantly, unlike the rigid nature of conventional customizable environments, in the named collaborative space of the present invention, any number and type of logical components can be included in the named collaborative space as specified by a template and rendered at run-time in order to produce a highly customizable and flexible collaborative computing environment.

In accordance with the present invention, the named collaborative space can be further extended to include both synchronous and asynchronous components. The synchronous components can include logical applications which facilitate the synchronous collaboration between individual collaborators in the collaborative environment. A non-limiting set of exemplary synchronous collaborative applications might include instant messaging, a chat room, a shared application, and an e-meeting. By comparison, the asynchronous components can include logical applications which facilitate asynchronous collaboration between individual collaborators. Again, a non-limiting set of exemplary asynchronous collaborative applications might include a document library and a discussion forum. Importantly, the mix of asynchronous and synchronous components in a named collaborative space can be selected in a self-provisioning, ad hoc fashion by the administrative collaborator limited only by policies governing the ability of the administrative collaborator to define and provision the creation of a named collaborative space.

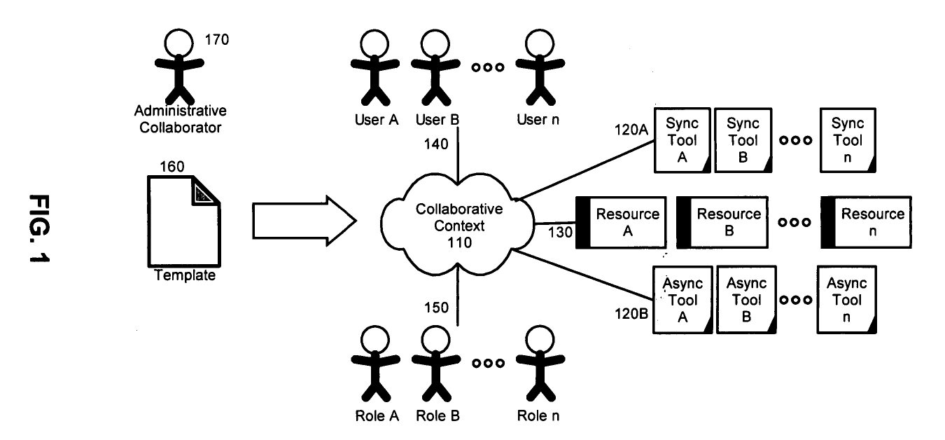

In further illustration of the general principle of the present invention, FIG. 1 is a pictorial illustration of a collaborative context configured to combine therein both synchronous and asynchronous components in a self-provisioning, on-demand manner. The collaborative context 110 can include an arrangement of collaborators in a membership 140, roles 150 assigned to the collaborators in the membership 140, resources 130 which can be accessed and consumed by the collaborators in the membership 140, and logical components 120A, 120B referred to as tools which can be used by the collaborators in the membership 140 for the purpose of working towards the collaborative objective of the collaborative context 110. Importantly, the tools 120A, 120B can include both synchronous tools 120A and asynchronous tools 120B.

The collaborators in the membership 140 can be computing users defined within a directory structure. Also, the collaborators in the membership 140 can be associated with one or more roles 150. Each of the roles 150 can include permissions associated with collaborators in the membership 140 assigned to the role. The permissions can include which of the tools 120A, 120B can be accessed by the collaborators assigned to a specific one of the roles 150, and the extent to which the collaborators in the role can access the tools 120A, 120B. The roles 150 also can limit which of the resources 130 can be accessed and consumed by the collaborators assigned to the roles 150.

The tools 120A, 120B in the named collaborative space 110 can include logical processes, such as self-contained computing applications, servlets, or portlets, which can be formed from a single set of computing logic, or from a composition of multiple sets of computing logic. The tools 120A, 120B can include both conventional business logic, as well as other logic, for instance logic for managing the membership 140, the roles 150, and the resources 130. In any case, in a preferred aspect of the present invention, the collaborative context 110 can be implemented within a portal environment in which the tools 120A, 120B can be portlet representations dynamically aggregated within the portal environment. To that end, a template defining the collaborative context 110 can be processed in the portal aggregator to establish the specified arrangement of tools within the portal view.

According to the present invention, an administrative collaborator 170 in the membership 140 (empowered by way of a role 150 associated with the administrative collaborator 170) can name a new collaborative context 110. The administrative collaborator 170 additionally can select one or more collaborators in the membership 140 to be included in the collaborative context 110 and one or more roles 150 can be assigned to the selected collaborators. The administrative collaborator 170 further can select one or more resources 130 to be included in the collaborative context 110, which resource selection can be limited by a resource limiting policy (not shown). In this regard, the resource limiting policy can define limitations upon the provisioning of resources by particular collaborators in order to prevent an over-allocation or inefficient allocation of resources which naturally can arise from the self-provisioning nature of the system of the present invention.

Importantly, the administrative collaborator 170 can select a unique mix of synchronous tools 120A and asynchronous tools 120B for incorporation in the collaborative context 110. Once selected, each of the selected collaborators in the membership 140, the assigned roles 150, the selected resources 130, and the synchronous and asynchronous tools 120A, 120B can be defined within a template 160. Using the template 160, instances of the defined collaborative context 110 can be created on demand by collaborators in the membership 140. Once created, the instance of the collaborative context 110 can include both the synchronous and asynchronous tools 120A, 120B. Preferably, the instances can be created within a portal environment.

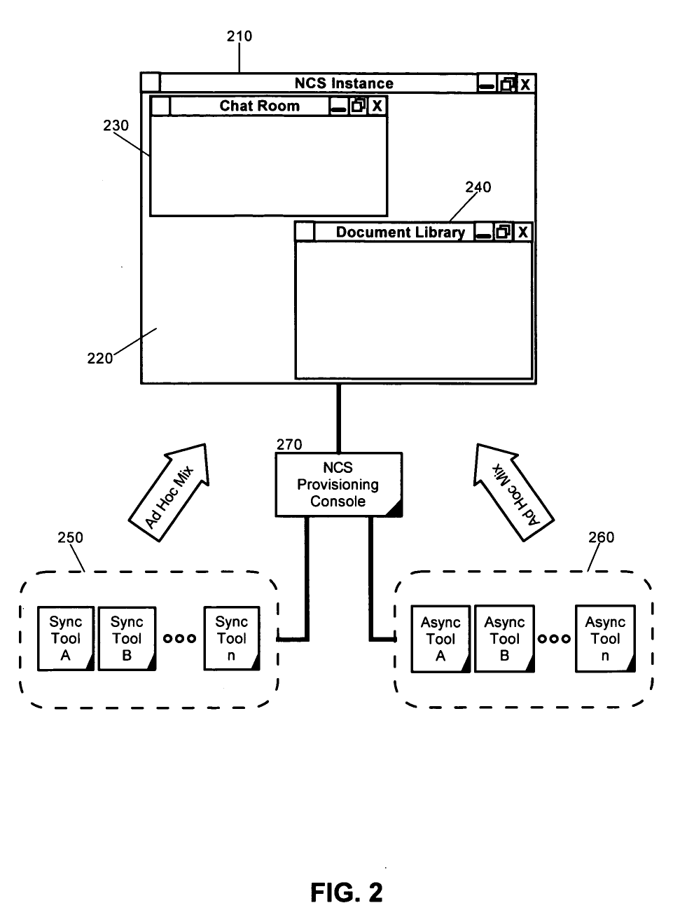

In more particular illustration, FIG. 2 is a schematic illustration of a named collaborative context instance created from an ad hoc combination of synchronous and asynchronous components. Specifically, a named collaborative space provisioning console 270 can be rendered for the benefit of collaborators in a collaborative environment who have been empowered to define and provision instances of named collaborative spaces. A non-exclusive set of synchronous tools 250 can be located and listed through the provisioning console 270. Similarly, a non-exclusive set of asynchronous tools 260 can be located and listed through the provisioning console 270. Both the synchronous tools 250 and asynchronous tools 260 can reside locally within the same domain as the provisioning console 270, or remotely across a computer communications network.

Once listed, an ad hoc mix of the synchronous tools 250 and asynchronous tools 260 can be selected for inclusion in a defined named collaborative context. Once defined, individual collaborators can provision instances of the named collaborative context. Additionally, existing member collaborators of an instance of the named collaborative context can access the portal user interface of the named collaborative context in order to access the synchronous and asynchronous tools included in the mix defined for the named collaborative context. For example, as shown in FIG. 2, a portal user interface 220 for a named collaborative context instance 210 can include both a synchronous tool 230 and an asynchronous tool 240.

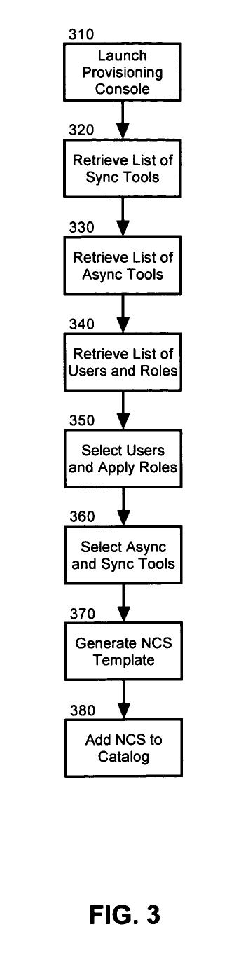

FIG. 3 is a flow chart illustrating a process for creating a template for named collaborative context instances including dynamically selectable combinations of synchronous and asynchronous components. Beginning in block 310, a provisioning console can be launched for use by an authorized collaborator. In block 320, a list of synchronous tools available for inclusion in defining a named collaborative space can be retrieved. Similarly, in block 330 a list of asynchronous tools available for inclusion in defining a named collaborative space can be retrieved. Finally, in block 340 a list of available user and corresponding roles can be retrieved.

In block 350, individual ones of the users can be selected from among the list of available users for inclusion in the named collaborative space. Subsequently, one or more of the roles in the list can be applied to the selected users. In block 360, an ad hoc mix of synchronous and asynchronous tools can be selected for inclusion in the named collaborative space. Finally, a template for the newly defined named collaborative space can be created and the newly defined named collaborative space can be added to a catalog listing of available named collaborative spaces from which new instances can be created by authorized collaborators.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A named collaborative space comprising:
a selection of collaborators in a membership;
at least one role applied to said collaborators;
a selection of resources for use by said collaborators; and,
an ad hoc mix of synchronous and asynchronous tools.

2. The named collaborative space of claim 1, further comprising a template defining said selection of collaborators, said at least one role applied to said collaborators, said selection of resources, and said ad hoc mix.

3. A named collaborative space instance comprising:
a selection of collaborators in a membership;
at least one role applied to said collaborators;
a selection of resources for use by said collaborators;
an ad hoc mix of synchronous and asynchronous tools; and,
a portal user interface encapsulating said ad hoc mix of synchronous and asynchronous tools.

4. A named collaborative space creation method comprising the steps of:
rendering each of a list of collaborators in a membership, a list of roles which can be applied to said collaborators, a selection of resources which can be used by said collaborators, and a listing of a set of synchronous tools and asynchronous tools which can be accessed by said collaborators;
selecting a set of collaborators from said list of collaborators and applying selected ones of said roles to individual ones of said collaborators;
further selecting at least one resource for use by said selected set of collaborators;
yet further selecting an ad hoc mix of said synchronous and asynchronous tools for use by said selected set of collaborators; and,
defining the named collaborative space with said selected set of collaborators, said further selected at least one resource, and said yet further selected ad hoc mix of tools.

5. The method of claim 4, wherein said defining step further comprises the step of persisting said definition in a template configured for use in creating instances of the named collaborative space.

6. The method of claim 4, further comprising the step of registering the named collaborative space in a catalog for viewing in a collaborative environment.

7. The method of claim 4, further comprising the step of creating an instance of the named collaborative space.

8. The method of claim 7, further comprising the step of limiting said creation of said instance by an administrative collaborator based upon at least one role assigned to said administrative collaborator.

9. The method of claim 7, further comprising the step of rendering said instance in a portal user interface.

10. A machine readable storage having stored thereon a computer program for named collaborative space creation, the computer program comprising a routine set of instructions which when executed by a machine cause the machine to perform the steps of:
rendering each of a list of collaborators in a membership, a list of roles which can be applied to said collaborators, a selection of resources which can be used by said collaborators, and a listing of a set of synchronous tools and asynchronous tools which can be accessed by said collaborators;
selecting a set of collaborators from said list of collaborators and applying selected ones of said roles to individual ones of said collaborators;
further selecting at least one resource for use by said selected set of collaborators;
yet further selecting an ad hoc mix of said synchronous and asynchronous tools for use by said selected set of collaborators; and,
defining the named collaborative space with said selected set of collaborators, said further selected at least one resource, and said yet further selected ad hoc mix of tools.

11. The machine readable storage of claim 10, wherein said defining step further comprises the step of persisting said definition in a template configured for use in creating instances of the named collaborative space.

12. The machine readable storage of claim 10, further comprising the step of registering the named collaborative space in a catalog for viewing in a collaborative environment.

13. The machine readable storage of claim 10, further comprising the step of creating an instance of the named collaborative space.

14. The machine readable storage of claim 13, further comprising the step of limiting said creation of said instance by an administrative collaborator based upon at least one role assigned to said administrative collaborator.

15. The machine readable storage of claim 13, further comprising the step of rendering said instance in a portal user interface.
